(19) United States
(12) Patent Application Publication
(10) Pub. No.: US 2026/0222125 A1
(43) Pub. Date: Jul. 30, 2026

(54) ENHANCED LINK ADAPTATION

(71) Applicant: QUALCOMM Incorporated, San Diego, CA (US)

(72) Inventors: Ming YANG, San Diego, CA (US); Kausik RAY CHAUDHURI, San Diego, CA (US); Juan MONTOJO, San Diego, CA (US)

(21) Appl. No.: 19/038,624

(22) Filed: Jan. 27, 2025

(51) Int. Cl. H04L 1/20; H04B 7/06; H04W 28/02

(52) U.S. Cl. CPC H04L 1/203; H04B 7/0626; H04W 28/0268

(57) ABSTRACT

An apparatus may comprise one or more memories, individually or in combination, having instructions. The apparatus may comprise one or more processors, individually or in combination, configured to execute the instructions and cause the apparatus to: output an indication of a link adaptation capability for wireless communication between the apparatus and a wireless node, obtain, after the indication is output, configuration information associated with the link adaptation capability, the configuration information comprising an indication of a first block error rate (BLER) associated with a first link adaptation process independent of the apparatus; and output an indication of an apparatus-recommended metric that is based on the first BLER.

### BACKGROUND

Technical Field

The present disclosure generally relates to communication systems, and more particularly, to enhanced link adaptation.

Introduction

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

Aspects are directed to an apparatus for wireless communication. In some examples the apparatus includes one or more memories, individually or in combination, having instructions. In some examples, the apparatus includes one or more processors, individually or in combination, configured to execute the instructions. In some examples, the apparatus is configured to output an indication of a link adaptation capability for wireless communication between the apparatus and a wireless node. In some examples, the apparatus is configured to obtain, after the indication is output, configuration information associated with the link adaptation capability, the configuration information comprising an indication of a first block error rate (BLER) associated with a first link adaptation process independent of the apparatus. In some examples, the apparatus is configured to output an indication of an apparatus-recommended metric that is based on the first BLER.

Aspects are directed to an apparatus for wireless communication. In some examples, the apparatus includes one or more memories, individually or in combination, having instructions. In some examples, the apparatus includes one or more processors, individually or in combination, configured to execute the instructions. In some examples, the apparatus is configured to obtain an indication of a link adaptation capability for wireless communication between the apparatus and a wireless node. In some examples, the apparatus is configured to output, after the indication is obtained, configuration information associated with the link adaptation capability, the configuration information comprising an indication of a first block error rate (BLER) associated with a first link adaptation process independent of the apparatus. In some examples, the apparatus is configured to obtain an indication of a wireless node-recommended metric, wherein the wireless node-recommended metric is based on the first BLER.

Aspects are directed to a method for wireless communication at an apparatus. In some examples the method includes outputting an indication of a link adaptation capability for wireless communication between the apparatus and a wireless node. In some examples, the method includes obtaining, after the indication is output, configuration information associated with the link adaptation capability, the configuration information comprising an indication of a first block error rate (BLER) associated with a first link adaptation process independent of the apparatus. In some examples, the apparatus includes outputting an indication of an apparatus-recommended metric that is based on the first BLER.

Aspects are directed to a method for wireless communication at an apparatus. In some examples the method includes obtaining an indication of a link adaptation capability for wireless communication between the apparatus and a wireless node. In some examples, the method includes outputting, after the indication is obtained, configuration information associated with the link adaptation capability, the configuration information comprising an indication of a first block error rate (BLER) associated with a first link adaptation process independent of the apparatus. In some examples, the method includes obtaining an indication of a wireless node-recommended metric, wherein the wireless node-recommended metric is based on the first BLER.

Aspects are directed to an apparatus. In some examples the apparatus includes means for outputting an indication of a link adaptation capability for wireless communication between the apparatus and a wireless node. In some examples, the apparatus includes means for obtaining, after the indication is output, configuration information associated with the link adaptation capability, the configuration information comprising an indication of a first block error rate (BLER) associated with a first link adaptation process independent of the apparatus. In some examples, the apparatus includes means for outputting an indication of an apparatus-recommended metric that is based on the first BLER.

Aspects are directed to an apparatus. In some examples the apparatus includes means for obtaining an indication of a link adaptation capability for wireless communication between the apparatus and a wireless node. In some examples, the apparatus includes means for outputting, after the indication is obtained, configuration information associated with the link adaptation capability, the configuration information comprising an indication of a first block error rate (BLER) associated with a first link adaptation process independent of the apparatus. In some examples, the apparatus includes means for obtaining an indication of a wireless node-recommended metric, wherein the wireless node-recommended metric is based on the first BLER.

Aspects are directed to a non-transitory computer-readable medium comprising instructions that, when executed by an apparatus, cause the apparatus to perform a method. In some examples the method includes outputting an indication of a link adaptation capability for wireless communication between the apparatus and a wireless node. In some examples, the method includes obtaining, after the indication is output, configuration information associated with the link adaptation capability, the configuration information comprising an indication of a first block error rate (BLER) associated with a first link adaptation process independent of the apparatus. In some examples, the apparatus includes outputting an indication of an apparatus-recommended metric that is based on the first BLER.

Aspects are directed to a non-transitory computer-readable medium comprising instructions that, when executed by an apparatus, cause the apparatus to perform a method. In some examples the method includes obtaining an indication of a link adaptation capability for wireless communication between the apparatus and a wireless node. In some examples, the method includes outputting, after the indication is obtained, configuration information associated with the link adaptation capability, the configuration information comprising an indication of a first block error rate (BLER) associated with a first link adaptation process independent of the apparatus. In some examples, the method includes obtaining an indication of a wireless node-recommended metric, wherein the wireless node-recommended metric is based on the first BLER.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4 is a block diagram illustrating an example disaggregated base station architecture.

FIG. 5 illustrates two graphs including a first graph and a second graph.

FIG. 6 is a call-flow diagram illustrating example communications between a UE and a network entity.

FIG. 7 is a flowchart of a method of wireless communication.

FIG. 8 is a diagram illustrating an example of a hardware implementation for an example apparatus.

FIG. 9 is a flowchart of a method of wireless communication.

FIG. 10 is a diagram illustrating another example of a hardware implementation for another example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

In 5G wireless communication, “link adaptation” relates to a dynamic adjustment of communication parameters to optimize a wireless link between a transmitter (e.g., a network entity) and a receiver (e.g., a user equipment (UE)). This process may include modifying parameters such as modulation schemes, coding rates, multiple-input multiple-output (MIMO) layers, and/or transmission power based on the current conditions of a wireless channel. Ultimately, a primary purpose of link adaptation is to maximize data throughput and maintain a reliable connection by adapting to various channel conditions caused by interference, signal fading, mobility, etc.

In certain aspects, link adaptation has been observed as functioning relatively slowly and with relatively low effectivity in instances between wireless nodes with a significant gap between UE-reported spectral efficiency (SPEF) and network-scheduled SPEF. As used herein, a UE-reported SPEF may relate to signal and channel quality parameters as observed by a UE, and may include parameters such as a channel quality indicator (CQI), a precoding matrix indicator (PMI), and/or a rank indicator (RI). Such channel quality parameters may be determined by a UE based on channel state information (CSI) and may be used for link adaptation and MIMO transmission. Specifically, the CQI may relate to a measure of downlink channel quality reported by the UE to the network entity. For example, the UE may report SPEF by measuring its signal-to-interference-plus-noise ratio (SINR) and converting it into a CQI value, which is then sent to the network entity as part of a measurement report. This CQI value may indirectly reflect the UE's achievable SPEF based on current channel conditions.

A network-scheduled SPEF may relate to a measure of how effectively a network schedule utilizes the available radio spectrum, essentially calculating the amount of data that can be transmitted per unit of bandwidth within a given network schedule. The network scheduled SPEF may be expressed in terms of bits per second per Hertz (bps/Hz), and calculation of a network-scheduled SPEF may consider factors like user distribution, channel conditions, and resource allocation across different time slots within the schedule. For example, a UE scheduled to receive data transmitted by the network entity via 20 out of 100 contiguous downlink slots represents a 20% scheduling rate.

Generally, the UE may be configured with a UE-specific block error rate (BLER) to generate or calculate a CQI. According to current third generate partnership project (3GPP) standards, the UE-specific BLER target is 10%, meaning that the UE should successfully decode at least 90% of the data blocks transmitted to it. In certain aspects, a UE-calculated CQI value is configured to indicate the highest MCS that can be supported by the downlink channel while meeting the UE-specific BLER target. Thus, the network entity in communication with the UE may use the CQI to adapt the MCS and other transmission parameters for downlink communications to the UE. It should be noted that the BLER associated with a particular device may be used by that device to perform CSI measurements and CSI reporting.

However, the UE-specific BLER target may be different from the BLER target used by the network entity. For example, the network entity BLER target may be more strict or more lenient (e.g., ranging from 5% to 20%). This disparity between the UE-specific BLER target and the network entity BLER target may contribute to the gap between UE-reported SPEF and network-scheduled SPEF, and thus, contribute to a relatively less effective link adaptation between the UE and network entity.

Accordingly, to enhance effectivity and speed of link adaptation between the UE and network entity, the network entity may provide the UE with an indication of the network entity BLER target, and the UE may adjust its link adaptation process (e.g., including CSI measuring and reporting) such that the UE uses the network entity BLER target instead of the UE-specific BLER target.

In some examples, the UE may measure both UE-reported SPEF and network-scheduled SPEF. The UE may then determine if a difference between the UE-reported SPEF and network-scheduled SPEF is above a threshold (e.g., the gap is greater than or equal to a value). Alternatively, or in addition, the UE may determine if one or more the UE-reported SPEF and the network-scheduled SPEF satisfies a threshold condition. If one or more of the aforementioned threshold conditions last or continue to exist for a pre-configured duration of time, the UE may determine a recommended adjustment to one or more channel quality parameters (e.g., MCS adjustment, MIMO layer adjustment, transport block (TB) change, etc.), and report eh recommended adjustment to the network entity to facilitate enhanced link adaptation.

Accordingly, aspects described herein enhance link adaptation by providing a network entity with information to determine MCS and/or MIMO layers based on SPEF differences reported by the UE.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

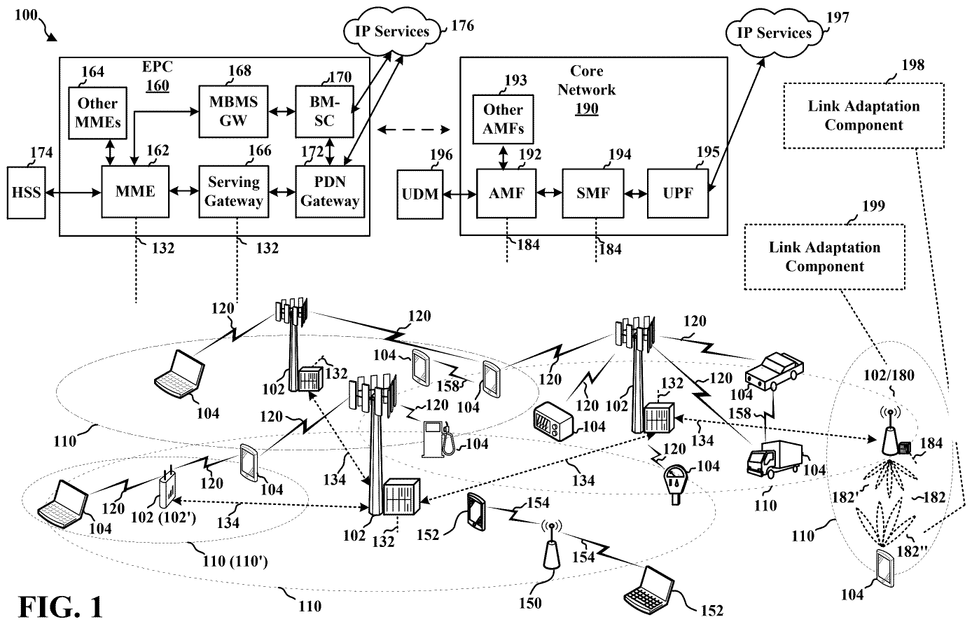

FIG. 1 is a diagram illustrating an example of a wireless communications system and an access network 100. The wireless communications system (also referred to as a wireless wide area network (WWAN)) includes base stations 102, user equipment(s) (UE) 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G Long Term Evolution (LTE) (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G New Radio (NR) (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, Multimedia Broadcast Multicast Service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′may have a coverage area 110′that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y megahertz (MHz) (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 gigahertz (GHz) unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR 1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHz, may be within FR 1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, an MBMS Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides Quality of Service (QoS) flow and session management. All user IP packets are transferred through the UPF 195. The UPF 195 provides UE IP address allocation as well as other functions. The UPF 195 is connected to the IP Services 197. The IP Services 197 may include the Internet, an intranet, an IMS, a Packet Switch (PS) Streaming Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. A wireless node may comprise a UE, a base station, or a network entity.

Referring again to FIG. 1, the UE 104 may include a link adaptation component 198 configured for enhanced link adaptation. As described in more detail elsewhere herein, the link adaptation component 198 may be configured to: output an indication of a link adaptation capability for wireless communication between the apparatus and a wireless node; obtain, after the indication is output, configuration information associated with the link adaptation capability, the configuration information comprising an indication of a first block error rate (BLER) associated with a first link adaptation process independent of the apparatus; and output an indication of an apparatus-recommended metric that is based on the first BLER. Additionally, or alternatively, the link adaptation component 198 may perform one or more other operations described herein.

The base station 102/180 may include a link adaptation component 199 configured for enhanced link adaptation. As described in more detail elsewhere herein, the link adaptation component 199 may be configured to: obtain an indication of a link adaptation capability for wireless communication between the apparatus and a wireless node; output, after the indication is obtained, configuration information associated with the link adaptation capability, the configuration information comprising an indication of a first block error rate (BLER) associated with a first link adaptation process independent of the apparatus; and obtain an indication of a wireless node-recommended metric, wherein the wireless node-recommended metric is based on the first BLER. Additionally, or alternatively, the link adaptation component 199 may perform one or more other operations described herein.

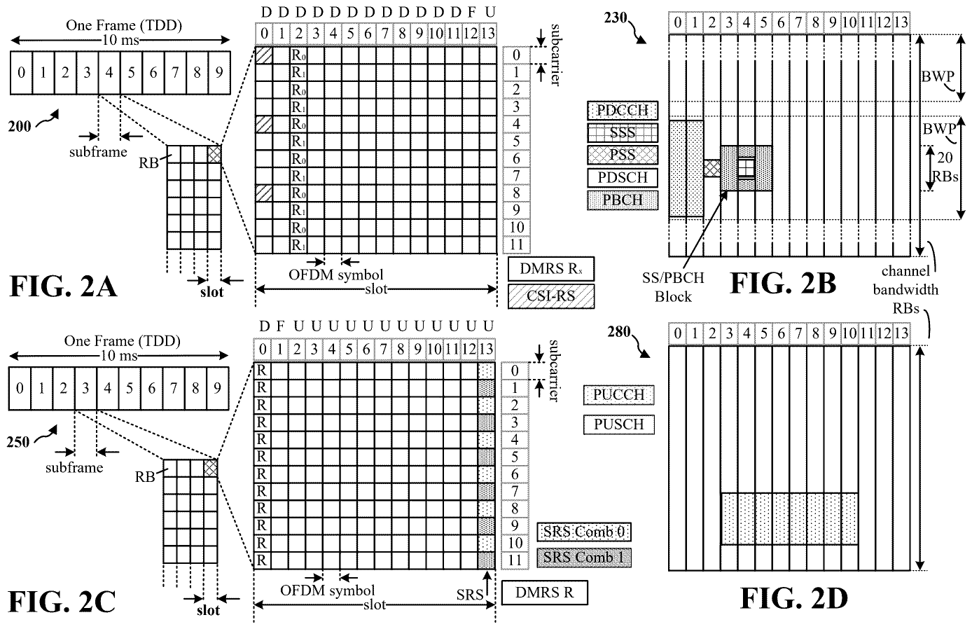

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure and/or different channels. A frame, e.g., of 10 milliseconds (ms), may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) orthogonal frequency-division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ0 to 4 allow for 1, 2, 4, 8, and 16 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ}slots/subframe. The subcarrier spacing and symbol length/duration are a function of the numerology. The subcarrier spacing may be equal to 2^{μ}*15 kilohertz (kHz), where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rₓ for one particular configuration, where 100× is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A PDCCH within one BWP may be referred to as a control resource set (CORESET). Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgement (ACK)/non-acknowledgement (NACK) feedback. The PUSCH carries data, and may additionally be used to carry a buffer status report (BSR), a power headroom report (PHR), and/or UCI.

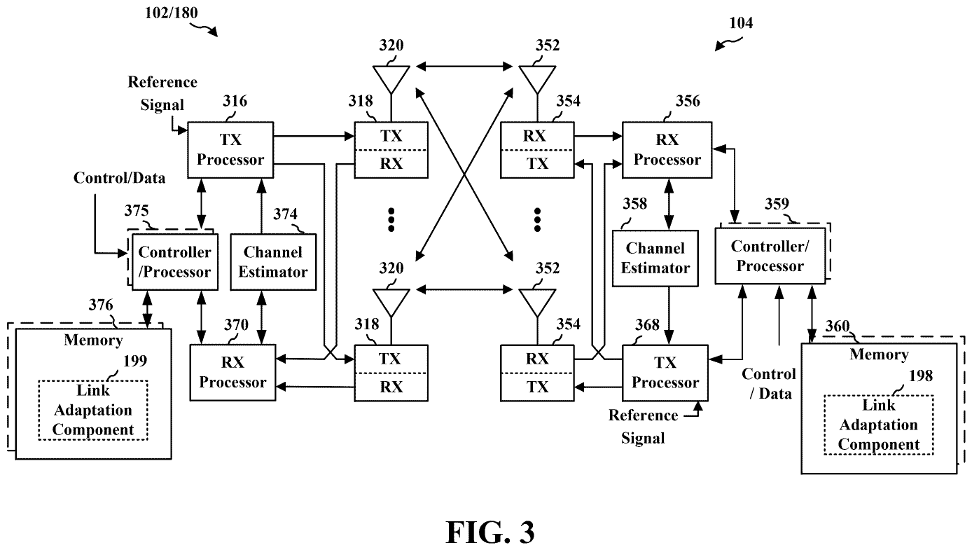

FIG. 3 is a block diagram of a base station 102/180 in communication with a UE 104 in an access network. In the DL, IP packets from the EPC 160 may be provided to one or more controller/processors 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 104. Each spatial stream may then be provided to a different antenna 320 via a separate transmitter 318TX. Each transmitter 318TX may modulate an RF carrier with a respective spatial stream for transmission.

At the UE 104, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 104. If multiple spatial streams are destined for the UE 104, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 102/180. These soft decisions may be based on channel estimates computed by the channel estimator 358. The soft decisions are then decoded and deinterleaved to recover the data and control signals that were originally transmitted by the base station 102/180 on the physical channel. The data and control signals are then provided to the controller/processor 359, which implements layer 3 and layer 2functionality.

The controller/processor 359 can be associated with a memory 360 that stores program codes and data. The memory 360 may be referred to as a computer-readable medium and may be any of the types of computer-readable mediums discussed herein (e.g., RAM, ROM, EEPROM, optical disk storage, magnetic disk storage, other magnetic storage devices, combinations of the aforementioned types of computer-readable media, or any other medium that can be used to store computer executable code in the form of instructions or data structures that can be accessed by a computer). In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 102/180, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 102/180 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 102/180 in a manner similar to that described in connection with the receiver function at the UE 104. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium and may be any of the types of computer-readable mediums discussed herein (e.g., RAM, ROM, EEPROM, optical disk storage, magnetic disk storage, other magnetic storage devices, combinations of the aforementioned types of computer-readable media, or any other medium that can be used to store computer executable code in the form of instructions or data structures that can be accessed by a computer). In the UL, the controller/processor 375 provides demultiplexing between transport and logical channels, packet reassembly, deciphering, header decompression, control signal processing to recover IP packets from the UE 104. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with 198 of FIG. 1.

At least one of the TX processor 316, the RX processor 370, and the controller/processor 375 may be configured to perform aspects in connection with 199 of FIG. 1.

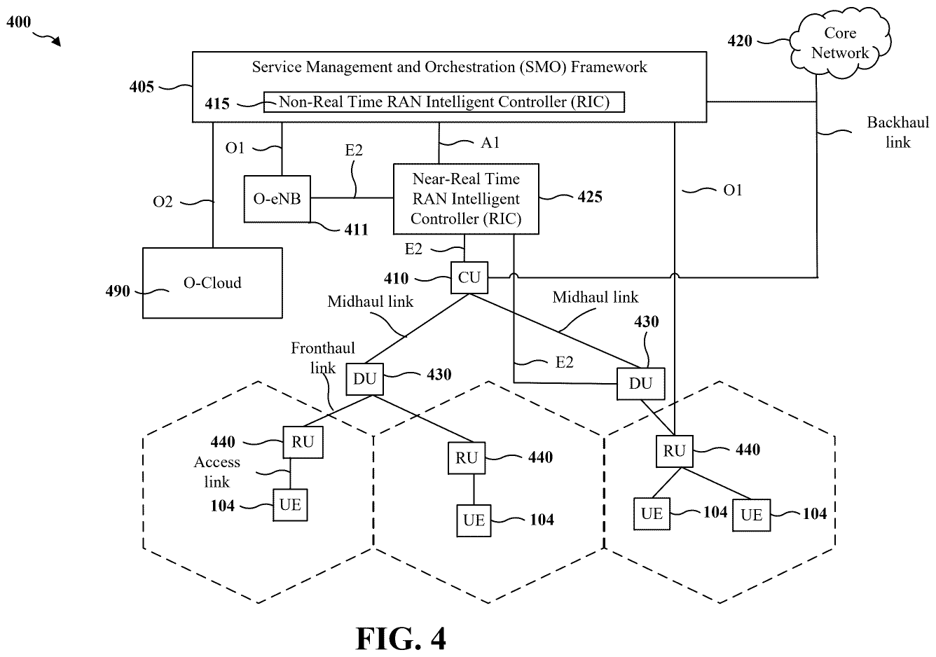

FIG. 4 is a block diagram illustrating an example disaggregated base station 400 architecture. The disaggregated base station 400 architecture may include one or more CUs 410 that can communicate directly with a core network 420 via a backhaul link, or indirectly with the core network 420 through one or more disaggregated base station units (such as a near real-time (RT) RIC 425 via an E2 link, or a non-RT RIC 415 associated with a service management and orchestration (SMO) Framework 405, or both). A CU 410 may communicate with one or more DUs 430 via respective midhaul links, such as an F1 interface. The DUs 430 may communicate with one or more RUs 440 via respective fronthaul links. The RUs 440 may communicate with respective UEs 104 via one or more radio frequency (RF) access links. In some implementations, the UE 104 may be simultaneously served by multiple RUs 440. As used herein, a network entity may correspond to a base station or to a disaggregated aspect (e.g., CU/DU/RU, etc.) of the base station.

Each of the units, i.e., the CUs 410, the DUs 430, the RUs 440, as well as the near-RT RICs 425, the non-RT RICs 415 and the SMO framework 405, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include one or more receivers, one or more transmitters or transceivers (such as one or more radio frequency (RF) transceivers), configured to receive or transmit signals, or both, over a wireless transmission medium to one or more of the other units.

In some aspects, the CU 410 may host higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 410. The CU 410 may be configured to handle user plane functionality (i.e., central unit - user plane (CU-UP)), control-plane functionality (i.e., central unit - control-plane (CU-CP)), or a combination thereof. In some implementations, the CU 410 can be logically split into one or more CU-UP units and one or more CU-CP units. The CU-UP unit can communicate bidirectionally with the CU-CP unit via an interface, such as the E1 interface when implemented in an O-RAN configuration. The CU 410 can be implemented to communicate with the DU 430, as necessary, for network control and signaling.

The DU 430 may correspond to a logical unit that includes one or more base station functions to control the operation of one or more RUs 440. In some aspects, the DU 430 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 430 may further host one or more low PHY layers. Each layer (or module) can be implemented with an interface configured to communicate signals with other layers (and modules) hosted by the DU 430, or with the control functions hosted by the CU 410.

Lower-layer functionality can be implemented by one or more RUs 440. In some deployments, an RU 440, controlled by a DU 430, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 440 can be implemented to handle over the air (OTA) communication with one or more UEs 104. In some implementations, real-time and non-real-time aspects of control and user plane communication with the RU(s) 440 can be controlled by the corresponding DU 430. In some scenarios, this configuration can enable the DU(s) 430 and the CU 410 to be implemented in a cloud-based RAN architecture, such as a virtual RAN (vRAN) architecture.

The SMO Framework 405 may be configured to support RAN deployment and provisioning of non-virtualized and virtualized network elements. For non-virtualized network elements, the SMO framework 405 may be configured to support the deployment of dedicated physical resources for RAN coverage requirements, which may be managed via an operations and maintenance interface (such as an Ointerface). For virtualized network elements, the SMO framework 405 may be configured to interact with a cloud computing platform (such as an open cloud (O-cloud) 490) to perform network element life cycle management (such as to instantiate virtualized network elements) via a cloud computing platform interface (such as an O2 interface). Such virtualized network elements can include, but are not limited to, CUs 410, DUs 430, RUs 440 and near-RT RICs 425. In some implementations, the SMO framework 405 can communicate with a hardware aspect of a 4G RAN, such as an open eNB (O-eNB) 411, via an O1 interface. Additionally, in some implementations, the SMO Framework 405 can communicate directly with one or more RUs 440 via an O1 interface. The SMO framework 405 also may include the non-RT RIC 415 configured to support functionality of the SMO Framework 405.

The non-RT RIC 415 may be configured to include a logical function that enables non-real-time control and optimization of RAN elements and resources, artificial intelligence/machine learning (AI/ML) workflows including model training and updates, or policy-based guidance of applications/features in the near-RT RIC 425. The non-RT RIC 415 may be coupled to or communicate with (such as via an A1interface) the near-RT RIC 425. The near-RT RIC 425 may be configured to include a logical function that enables near-real-time control and optimization of RAN elements and resources via data collection and actions over an interface (such as via an E2 interface) connecting one or more CUs 410, one or more DUs 430, or both, as well as an O-eNB, with the near-RT RIC 425.

In some implementations, to generate AI/ML models to be deployed in the near-RT RIC 425, the non-RT RIC 415 may receive parameters or external enrichment information from external servers. Such information may be utilized by the near-RT RIC 425 and may be received at the SMO Framework 405 or the non-RT RIC 415 from non-network data sources or from network functions. In some examples, the non-RT RIC 415 or the near-RT RIC 425 may be configured to tune RAN behavior or performance. For example, the non-RT RIC 415 may monitor long-term trends and patterns for performance and employ AI/ML models to perform corrective actions through the SMO Framework 405 (such as reconfiguration via O1) or via creation of RAN management policies (such as A1 policies).

### Examples of Concurrent Scheduling of Ue-level Control-plane and User-plane Information

In certain aspects, the control-plane relates to signaling and control messages typically configured to manage connection setup, maintenance, and teardown, as well as mobility management, authentication, and other control functions of the network and/or UE. The user-plane typically relates to actual user data transmissions, such as voice, video, and internet traffic. Thus, it may relate to data payloads that a UE is sending or receiving.

In some examples, UE-level control-plane data and user-plane data may be concurrently scheduled. For example, the two types of data may be managed and transmitted simultaneously. By handling both types of data concurrently, the network can reduce latency and enhance the overall user experience. This is particularly important for applications requiring real-time data transmission, such as video calls or online gaming. Concurrent scheduling also provides for efficient utilization of network resources. For example, it can ensure that the available bandwidth is used effectively, balancing the needs of control signaling and user data transmission.

Different types of concurrent scheduling may be used in a wireless communication system, with the different types offering tradeoffs related to spectral efficiency (SPEF). For example, the different types may include “reliable concurrent scheduling” (e.g., reliable_concurrent_sch) and “high spectral efficiency concurrent scheduling” (e.g., high_se_concurrent_sch). Although not a concurrent type of scheduling, “separate scheduling” (e.g., separate_sch) may also be used.

In some examples, with reliable concurrent scheduling, a network entity may allow scheduling of both UE-level control-plane information and user-plane information in the same slot but with a relatively low code rate. In some scenarios, reliable concurrent scheduling is used when CCEs are insufficient. Due to the low coding rate, reliability may be improved at the expense of SPEF.

In some examples, with high spectral efficiency concurrent scheduling, the network entity may allow transmission of both UE-level control-plane information and user-plane information for a UE in the same slot but with a relatively higher code rate. Such UE-level concurrent scheduling may be used in heavy-load scenarios (e.g., with the downlink PRB usage being greater than 95%). Thus, high spectral efficiency concurrent scheduling may improve SPEF at the expense of reliability.

In some examples, separate scheduling of UE-level control-plane information and user-plane relates to scheduling that is not concurrent (e.g., UE-level control-plane information and user-plane information are not scheduled in the same slot). This type of scheduling is good for both reliability and SPEF, but may negatively impact power consumption and overhead due to more complex scheduling.

### Examples of UE-reported SPEF versus Network-Scheduled SPEF

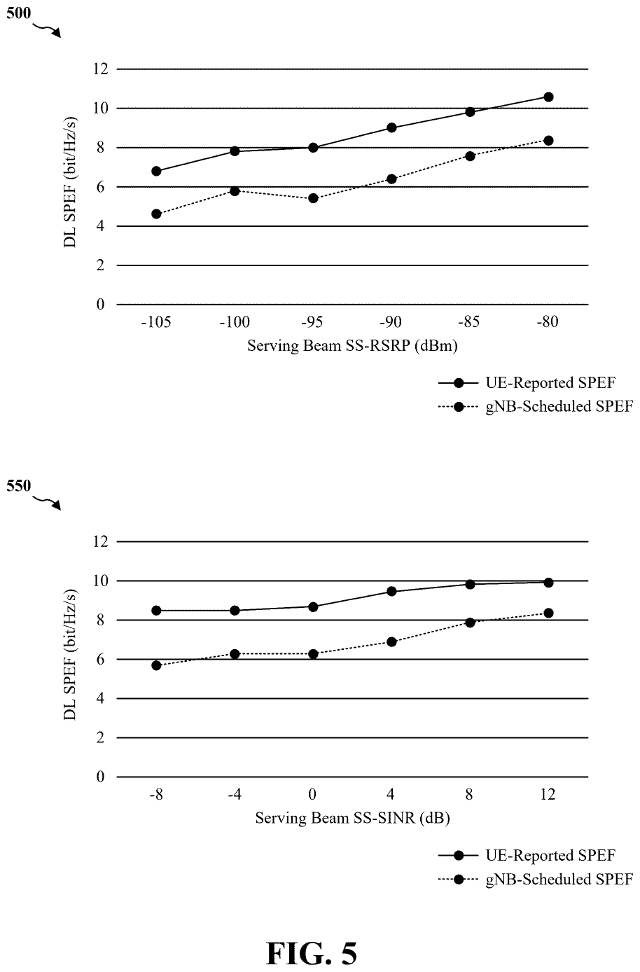

FIG. 5 illustrates two graphs including a first graph 500 and a second graph 550. The first graph 500 illustrates a gap between UE-reported SPEF and network-scheduled SPEF in terms of signal strength (e.g., RSRP), and the second graph 550 illustrates a gap between UE-reported SPEF and network-scheduled SPEF in terms of signal quality (e.g., SINR). Each graph illustrates UE-reported SPEF and network-scheduled SPEF based on typical communications between a UE and a network node (e.g., gNB). Here, the y-axis of both graphs indicates how efficiently the available spectrum is being used to transmit downlink data. Higher values indicate better utilization of the spectrum, meaning more data is being transmitted per unit of bandwidth. The UE-reported SPEF is consistently around 30% higher than network-scheduled SPEF. This 30% being the gap between UE-reported SPEF and network-scheduled SPEF.

As discussed, link adaptation between wireless devices may be slowed as the gap between UE-reported SPEF and network-scheduled SPEF increases. Thus, aspects of the disclosure are directed to enhancing the speed at which link adaptation occurs between the wireless devices.

### Examples of Enhanced Link Adaptation

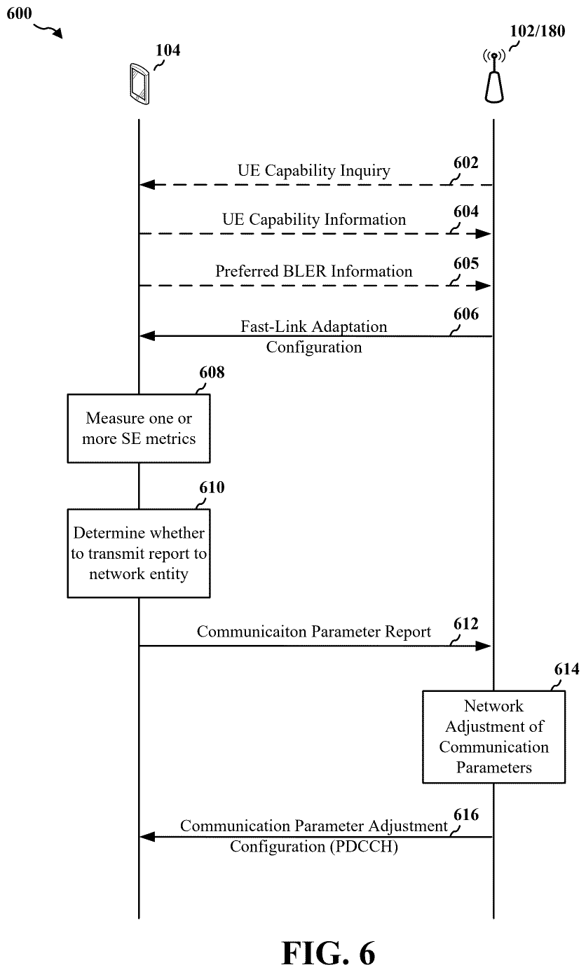

FIG. 6 is a call-flow diagram illustrating example communications 600 between a UE 104 (e.g., UE 104 of FIGS. 1 and 3) and a network entity 102 (e.g., network entity 102 of FIGS. 1 and 3, or RU 440, DU 430, or CU 410 of FIG. 4). Optional aspects are illustrated with a dashed line. The example communications 600 enhance a network's ability to reduce a gap between UE-reported SPEF and network-scheduled SPEF, and thereby enhance link adaptation between the UE and network.

At a first communication 602, the network entity 102 may transmit signaling to the UE 104, wherein the signaling is configured to inquire whether the UE 104 has a capability associated with enhanced link adaptation. For example, the UE 104 may be configured with a capability associated with enhanced link adaptation if the UE 104 can: measure one or more SPEF metrics, and transmit a SPEF report to the network entity 102 in response to satisfaction of one or more threshold conditions configured by the network entity 102. In some examples, the request is included in an RRC message (e.g., RRC (re)configuration).

At a second communication 604, the UE 104 may transmit information to the network entity 102, wherein the information is configured to indicate whether the UE 104 is configured with a capability associated with enhanced link adaptation. The second communication 604 may be transmitted by the UE 104 during RRC configuration or any other suitable time during communication between the UE 104 and network entity 102. The second communication 604 may be transmitted in response to the request associated with the first communication 602, or the second communication 604 may be unsolicited. In some examples, the information may indicate that the UE 104 is configured to support enhanced-link adaptation via RRC, MAC-CE, CSI report enhancement, or close-loop MCS adjustment, close-loop MIMO-layer adjustment, and/or close-loop TB size adjustment. In other words, the UE 104 may perform MCS, MIMO-layer, and/or TB size adjustments independent of a network command, and the UE 104 may transmit a report to the network entity 102 via any of an RRC, MAC-CE, or an enhanced CSI report.

At another communication 605, the UE 104 may transmit preferred BLER information to the network entity 102. Here, the UE 104 may determine a preferred BLER for a particular one or more flows, and transmit an indication of the preferred BLER and/or an indication of the associated one or more data flows. For example, different applications operating on the UE 104 may have different QoS requirements and/or RF conditions associated with their corresponding data flows. Moreover, the UE 104 may be configured with one or more BLER targets for link adaptation, depending on a particular data flow and/or application. For example, the UE 104 may be configured with a first preferred BLER (e.g., 2% target BLER) for a voice call application, but configured with a second preferred BLER (e.g., 10% target BLER) for a data flow for with another application. Thus, different applications may have different UE preferences for target BLER for link adaptation, and the UE 104 may transmit an indication of these preferences to the network entity 102. In some examples, the other communication 605 may be part of the second communication 604.

At a third communication 606, the network entity 102 may transmit link adaptation configuration information to the UE 104. The third communication 606 may be transmitted via an RRC (re)configuration message. In some examples, the link adaptation configuration information may be transmitted to the UE 104 in response to the second communication 604. Alternatively, the link adaptation configuration information may be transmitted independent of whether the first communication 602 and the second communication 604 even occur. The information may be configured to enable the UE 104 to measure and report information to the network entity 102 in support of enhanced link adaptation. The third communication 606 may be configured to enable the UE 104 to use enhanced-link adaptation.

As discussed, the UE 104 is typically (pre-)configured with a 10% BLER target to calculate and report CQI. However, the network entity 102 may configure the UE 104 to use the same BLER used by the network entity 102. Thus, in some examples, the information may include an indication of the network entity 102 BLER (e.g., a target BLER and/or dynamic BLER used for link adaptation by the network entity 102). Accordingly, the information may enable the UE 104 to use the BLER used by the network entity 102 to calculate CQI instead of using the (pre-)configured 10% BLER target intended for use by the UE 104. Alternatively, the network entity 102 may configure the UE 104 to use a BLER consistent with a preferred BLER indicated by the UE 104 in the second communication 604 or the other communication 605. In this example, the network entity 102 configure the UE 104 to use its preferred target BLER for a corresponding flow, and/or a network entity-specific target BLER for another flow.

In some examples, the information may include an indication of one or more threshold values associated with one or more SPEF metrics measured by the UE 104. For example, the UE 104 may be configured to measure and determine both UE-reported SPEF and network-scheduled SPEF. Thus, the one or more threshold values may include a first threshold value associated with a gap between the UE-reported SPEF and network-scheduled SPEF. Referring back to FIG. 5 as an example, if the first threshold value is 2 bits/Hz/s, then that threshold condition may be met if there is a 2 bits/Hz/s or greater gap between an actual measured UE-reported SPEF and network-scheduled SPEF. Here, if the threshold condition is met, then the UE 104 may be triggered to transmit a report (e.g., fourth communication 612, discussed in more detail below) to the network entity 102.

In some examples, the one or more threshold values may include a second threshold value associated with a value of network-scheduled SPEF. In this example, if an actual measured network-scheduled SPEF is equal to or below the second threshold value, then the UE 104 may be triggered to transmit the report to the network entity 102. In another example, the UE 104 may be triggered to transmit the report if the threshold conditions associated with both the first threshold value and the second threshold value are met (e.g., if a gap between an actual measured UE-reported SPEF and network-scheduled SPEF is greater than or equal to the first threshold value and if an actual measured network-scheduled SPEF is equal to or below the second threshold value).

In some examples, the one or more threshold values may include a third threshold value associated with a time-to-trigger (TTT) or another suitable indication of a time duration or a time window. In this example, if a condition associated with one or more of the first threshold or the second threshold is satisfied for the time duration of the TTT, then the UE 104 may be triggered to transmit the report. Stated differently, if the condition associated with one or more of the first threshold or the second threshold is not satisfied for the time duration of the TTT (e.g., the condition(s) is satisfied for a duration of time that is less than the TTT), then the UE 104 may refrain from transmitting the report.

At a first process 608, the UE 104 may measure one or more of the UE-reported SPEF and network-scheduled SPEF. The UE 104 may then determine whether the measured UE-reported SPEF and/or network-scheduled SPEF satisfies a corresponding threshold condition configured by the link adaptation configuration of the third communication 606. In one example, if the measured UE-reported SPEF and/or network-scheduled SPEF satisfies a corresponding threshold condition for a TTT duration of time, then the UE 104 may, at a second process 610, determine to transmit a report to the network entity 102.

In some examples, the UE 104 may also determine whether a delta or difference between the measured UE-reported SPEF and/or network-scheduled SPEF satisfies another threshold condition configured by the link adaptation configuration of the third communication 606. In one example, if the delta satisfies the threshold condition for a TTT duration of time, then the UE may, at the second process 610, determine to transmit the report to the network entity 102. In some examples, the UE may adjust its own CSI measurements based on the network indicated target/dynamic BLER. That is, the UE 104 may use network indicated BLER instead of BLER configured at UE (e.g., 10%). For example, the network entity 102 may transmit a CSI-RS signal, and the UE 104 may measure it and determine an RSRP and/or SINR based on the CSI-RS it receives. Here, instead of using the UE-configured BLER, the UE determines the CQI value using the measured values of the CSI-RS and the network entity-BLER.

In some examples, the UE 104 may measure signaling and determine one or more SPEF measurement values within a TTT. In one example, the UE 104 may measure a network-scheduled SPEF per slot or per CSI interval. If the network-scheduled SPEF is below a threshold and the SPEF delta or difference is above a threshold, the UE 104 may transmit a report to the network entity 102.

At the second process 610, the UE 104 may determine to transmit a report to the network entity 102 if one or more of the threshold conditions discussed above are satisfied. If a threshold condition is not satisfied, then the UE 104 may refrain from transmitting the report.

In certain aspects, the UE 104 may also determine a recommended MCS, a recommended MIMO layer, a recommended TB size, and/or a recommended QoS requirement. Here, the UE 104 may determine the recommended communication parameter(s) based on the measurements performed at the first process 608 and a CQI value that would result in the desired target BLER (e.g., the BLER used by the network entity 102 and provided to the UE 104). In other words, the UE 104 may determine one or more communication parameter values that would result in the target BLER.

In certain aspects, the UE 104 may also determine a recommended scheme for concurrent scheduling of UE-level control-plane and user-plane information. For example, the UE 104 may determine which scheme (e.g., reliable concurrent scheme, high SE concurrent scheme, separate scheme, or any other suitable scheme for scheduling UE-level control-plane and user-plane information) would result in a CQI value that would provide the desired target BLER.

At the fourth communication 612, the UE 104 may transmit an SPEF report. The SPEF report may include an indication of one or more communication parameters. In one example, the SPEF report may include an indication of a UE-recommended scheduling scheme (e.g., reliable_concurrent_sch, high_se_concurrent_sch, separate_sch). In some examples, the SPEF report may include, in addition or as an alternative to the scheduling scheme, an indication of one or more of: (i) a UE-recommended MCS, a UE-recommended MIMO layer(s), and/or a TB size.

The indication may be provided via an absolute value (e.g., an integer value, such as an index value that corresponds to a particular MCS), or a relative value. For example, if a current MCS being used by the UE 104 corresponds to MCS index value 6, and the UE-recommended MCS corresponds to MCS index value 8, then the SPEF report may include a relative value or offset value of 2 to indicate the UE-recommended MCS index value 8.

In some examples, the SPEF report may be transmitted via a MAC-CE (e.g., PUCCH), a physical uplink shared channel (PUSCH), or an enhanced CSI report. The enhanced CSI report may be configured with additional bits (e.g., 4 bits) configured to indicate the UE-recommended MCS, MIMO layer(s), TB size, and/or scheduling scheme. That is, the purpose of the additional bits is to allow the UE to indicate one or more recommended communication parameters via a CSI report.

At a third process 614, the network entity 102 may receive the SPEF report of the fourth communication 612, and adjust one or more communication parameters associated with its communication with the UE 104. In some examples, the network entity 102 may adjust the one or more communication parameters (e.g., the MCS, MIMO layer(s), TB size, scheduling scheme) to match the UE-recommended communication parameter value. However, the network entity 102 may refrain from making any adjustment to the communication parameters, or may adjust the communication parameters differently than what the UE recommended.

At a fifth communication 616, the network entity 102 may transmit an indication of a communication parameter adjustment to the UE 104 via a control channel (e.g., DCI, PDCCH).

As used herein, “enhanced link adaptation” relates to steps and processes used to improve link adaptation between wireless nodes. Such steps and processes include:
(i) UE transmission (e.g., second communication 604) indicating a UE-capability for enhanced link adaptation. In some examples, the indication of the UE-capability may include an indication of whether the UE can transmit a communication parameter report (e.g., fourth communication 612) via RRC, MAC-CE, or CSI enhanced report.

Such steps and processes may also include: (ii) network entity transmission (e.g., third communication 606) indicating a target BLER or dynamic BLER used by the network entity for its own link adaptation process. Here, the indication may configure the UE to use the target BLER or dynamic BLER instead of a UE-specific BLER.

Such steps and processes may also include: (iii) UE measurement of one or more spectral efficiency (SE) metrics (e.g., including a downlink spectrum difference between UE-reported SPEF and network-scheduled SPEF, as measured in the first process 608). If the difference satisfies one or more thresholds, for a TTT duration, the UE determine (e.g., based on a machine-learning (ML) and/or artificial intelligence (AI) algorithm, UE-mobility, and/or a QoS requirement associated with one or more apps) a recommended communication parameter (e.g., MCS/MIMO layers, coding rate, TB size, and/or scheduling scheme).

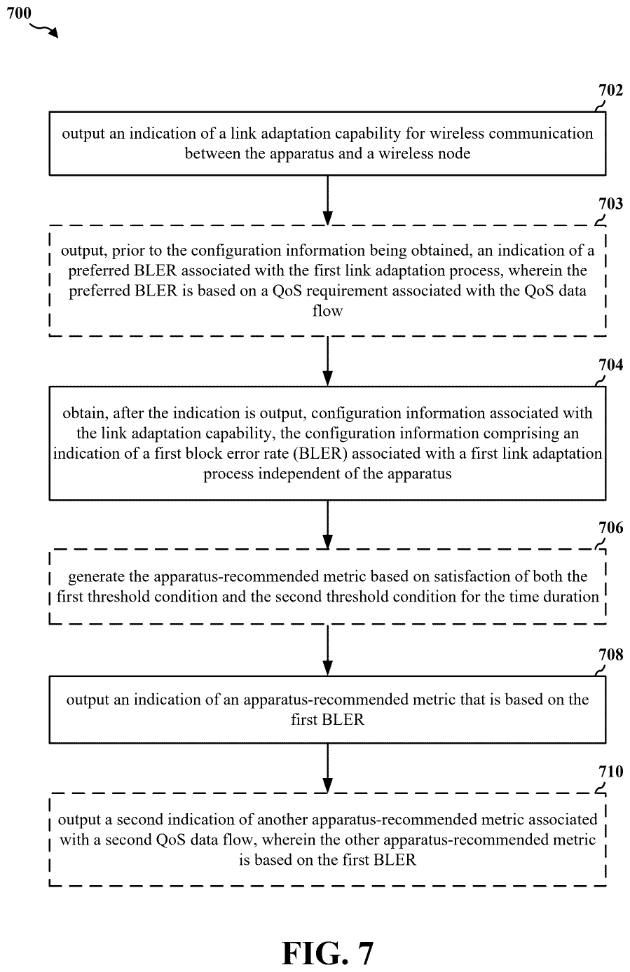

FIG. 7 is a flowchart 700 of a method of wireless communication. The method may be performed by a UE (e.g., the UE 104; the apparatus 802). Specifically, the method may be performed by one or more memories, processors, and RF front ends (e.g., the memory 360, controller/processor 359, transmitter 354TX, receiver 354RX, antenna 352, etc. of FIG. 3). Optional aspects are illustrated with a dashed line.

At 702, the UE may output an indication of a link adaptation capability for wireless communication between the UE and a wireless node. For example, 702 may be performed by an outputting component 840. Here, the UE may transmit (e.g., second communication 604 of FIG. 6) an indication that it supports an enhanced link adaptation capability.

At 703, the UE may output, prior to the configuration information being obtained, an indication of a preferred BLER associated with the first link adaptation process, wherein the preferred BLER is based on a QoS requirement associated with the QoS data flow. For example, 703 may be performed by the outputting component 840. Here, the UE may transmit an indication of one or more UE-specific BLER(s) associated with one or more QoS flows. In some examples, the network entity may configure the UE to use the preferred BLER for a particular one or more QoS flows. However, the network entity may also configure the UE to use a different target BLER (e.g., a network-entity specific BLER) as the first BLER.

At 704, the UE may obtain, after the indication is output, configuration information associated with the link adaptation capability, the configuration information comprising an indication of a first block error rate (BLER) associated with a first link adaptation process independent of the UE. For example, 704 may be performed by an obtaining component 842. Here, the network entity may transmit an indication of a target BLER or dynamic BLER that the network entity uses for its own link adaptation process. In other words, the target BLER or dynamic BLER may be different from what the UE uses for link adaptation. Thus, the network entity may change the BLER that the UE uses to evaluate a link from a UE-specific BLER to a BLER that matches the network entity.

At 706, the UE may generate the UE-recommended metric based on satisfaction of both the first threshold condition and the second threshold condition for the time duration. For example, 704 may be performed by a generating component 844. Here, the UE may use AI or ML to determine a UE-recommended communication parameter.

At 708, the UE may output an indication of a UE-recommended metric that is based on the first BLER. For example, 708 may be performed by the outputting component 840. Here, if one or more threshold conditions are satisfied for a defined duration of time (e.g., TTT), then the UE may determine a UE-recommended metric and transmit an indication (e.g., relative value or absolute) to the network entity.

Finally, at 710, the UE may output a second indication of another apparatus-recommended metric associated with a second QoS data flow, wherein the other apparatus-recommended metric is based on the first BLER. For example, 710 may be performed by the outputting component 840. For example, the UE may determine that one or more threshold conditions associated with the network entity-configured BLER are satisfied for multiple QoS flows. Accordingly, the UE may determine and transmit an indication a UE-recommended metric for each QoS flow.

In certain aspects, the first BLER comprises a target BLER or a dynamic BLER.

In certain aspects, the first BLER is different from a second BLER associated with a second link adaptation process performed by the apparatus.

In certain aspects, the first BLER comprises a wireless node-specific BLER, and the second BLER is an apparatus-specific BLER.

In certain aspects, the configuration information further comprises an indication of at least one of: (i) a first threshold condition associated with a scheduling rate, (ii) a second threshold condition associated with a spectral efficiency of the apparatus, or (iii) a time duration associated with one or more of the first threshold condition or the second threshold condition.

In certain aspects, the apparatus-recommended metric comprises one or more of: a modulation coding scheme (MCS), a multiple-input multiple-output (MIMO) layer, a transport block (TB) size, and a concurrent scheduling scheme for apparatus-level control-plane and user-plane information.

In certain aspects, the apparatus-recommended metric comprises an absolute value or a relative value associated with each of the one or more of the MCS, the MIMO layer, the TB size, and the concurrent scheduling scheme.

In certain aspects, the apparatus-recommended metric is output via a medium access control-control element (MAC-CE), a radio resource control (RRC) message, or a channel state information (CSI) report.

In certain aspects, the indication of the apparatus-recommended metric is a first indication associated with a first quality of service (QoS) data flow.

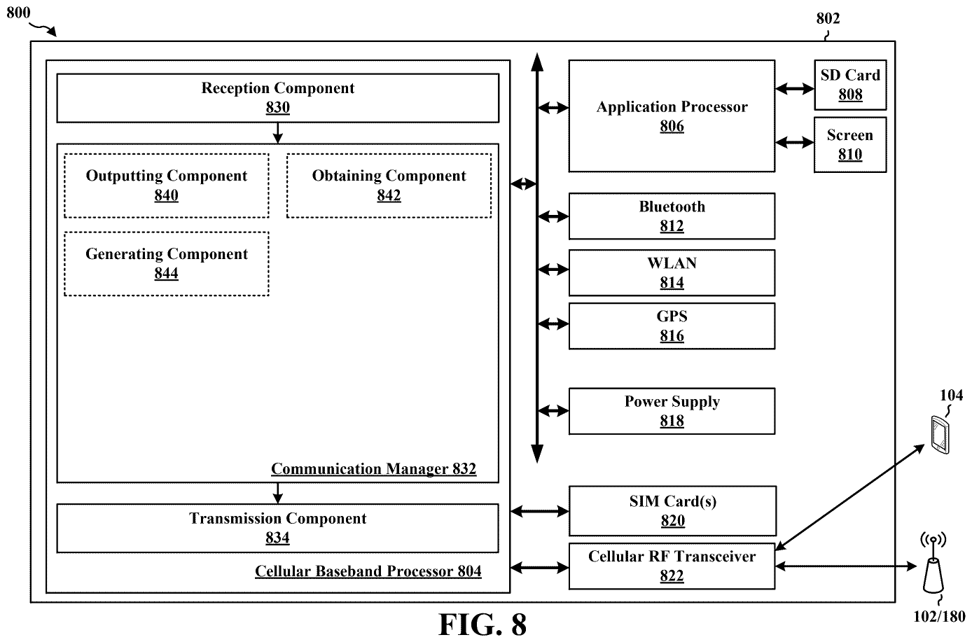

FIG. 8 is a diagram 800 illustrating an example of a hardware implementation for an apparatus 802. The apparatus 802 is a UE and includes a cellular baseband processor 804 (also referred to as a modem) coupled to one or more cellular RF transceivers 822 and one or more subscriber identity modules (SIM) cards 820, an application processor 806 coupled to a secure digital (SD) card 808 and a screen 810, a Bluetooth module 812, a wireless local area network (WLAN) module 814, a Global Positioning System (GPS) module 816, and a power supply 818. The cellular baseband processor 804 communicates through the one or more cellular RF transceivers 822 with the UE 104 and/or BS 102/180. The cellular baseband processor 804 may include a computer-readable medium/memory. The computer-readable medium/memory may be non-transitory. The cellular baseband processor 804 is responsible for general processing, including the execution of software stored on the computer-readable medium/memory. The software, when executed by the cellular baseband processor 804, causes the cellular baseband processor 804 to perform the various functions described supra. The computer-readable mediu/memory may also be used for storing data that is manipulated by the cellular baseband processor 804 when executing software. The cellular baseband processor 804 further includes a reception component 830, a communication manager 832, and a transmission component 834. The communication manager 832 includes the one or more illustrated components. The components within the communication manager 832 may be stored in the computer-readable medium/memory and/or configured as hardware within the cellular baseband processor 804. The cellular baseband processor 804 may be a component of the UE 104 and may include the memory 360 and/or at least one of the TX processor 368, the RX processor 356, and the controller/processor 359. In one configuration, the apparatus 802 may be a modem chip and include just the baseband processor 804, and in another configuration, the apparatus 802 may be the entire UE (e.g., see UE 104 of FIG. 3) and include the aforediscussed additional modules of the apparatus 802.

In various examples, the apparatus 802 can be a chip, SoC, chipset, package or device that may include: one or more modems (such as a Wi-Fi (IEEE 802.11) modem or a cellular modem such as 3 4G LTE or 5G compliant modem); one or more processors, processing blocks or processing elements (collectively “the processor”); one or more radios (collectively “the radio”); and one or more memories or memory blocks (collectively “the memory”).

The communication manager 832 includes an outputting component 840 that is configured to: output an indication of a link adaptation capability for wireless communication between the apparatus and a wireless node; output an indication of an apparatus-recommended metric that is based on the first BLER; output, prior to the configuration information being obtained, an indication of a preferred BLER associated with the first link adaptation process, wherein the preferred BLER is based on a QoS requirement associated with the QoS data flow; and output a second indication of another apparatus-recommended metric associated with a second QoS data flow, wherein the other apparatus-recommended metric is based on the first BLER; e.g., as described in connection with 702, 703, 708, and 710.

The communication manager 832 further includes an obtaining component 842 configured to: obtain, after the indication is output, configuration information associated with the link adaptation capability, the configuration information comprising an indication of a first block error rate (BLER) associated with a first link adaptation process independent of the apparatus, e.g., as described in connection with 704. The communication manager 832 further includes a generating component 844 configured to: generate the apparatus-recommended metric based on satisfaction of both the first threshold condition and the second threshold condition for the time duration, e.g., as described in connection with 706.

The apparatus may include additional components that perform each of the blocks of the algorithm in the aforementioned flowchart of FIG. 7. As such, each block in the aforementioned flowchart of FIG. 7 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 802, and in particular the cellular baseband processor 804, includes: means for outputting an indication of a link adaptation capability for wireless communication between the apparatus and a wireless node; means for obtaining, after the indication is output, configuration information associated with the link adaptation capability, the configuration information comprising an indication of a first block error rate (BLER) associated with a first link adaptation process independent of the apparatus; means for generating the apparatus-recommended metric based on satisfaction of both the first threshold condition and the second threshold condition for the time duration; means for outputting an indication of an apparatus-recommended metric that is based on the first BLER; and means for outputting a second indication of another apparatus-recommended metric associated with a second QoS data flow, wherein the other apparatus-recommended metric is based on the first BLER.

The aforementioned means may be one or more of the aforementioned components of the apparatus 802 configured to perform the functions recited by the aforementioned means. As described supra, the apparatus 802 may include the TX Processor 368, the RX Processor 356, and the controller/processor 359. As such, in one configuration, the aforementioned means may be the TX Processor 368, the RX Processor 356, and the controller/processor 359 configured to perform the functions recited by the aforementioned means.

Means for receiving or means for obtaining may include a receiver (such as the receive processor 370) and/or an antenna(s) 320 of the network entity 102/180 or the receive processor 356 and/or antenna(s) 352 of the UE 104 illustrated in FIG. 3. Means for transmitting or means for outputting may include a transmitter (such as the transmit processor 316) or an antenna(s) 320 of the network entity 102/180 or the transmit processor 368 or antenna(s) 352 of the UE 104 illustrated in FIG. 3. Means for generating may include a processing system, which may include one or more processors, such as the controller/processor 359, the memory 360, and/or any other suitable hardware components of the UE 104 illustrated in FIG. 3.

In some cases, rather than actually transmitting a frame a device may have an interface to output a frame for transmission (a means for outputting). For example, a processor may output a frame, via a bus interface, to a radio frequency (RF) front end for transmission. Similarly, rather than actually receiving a frame, a device may have an interface to obtain a frame received from another device (a means for obtaining). For example, a processor may obtain (or receive) a frame, via a bus interface, from an RF front end for reception.

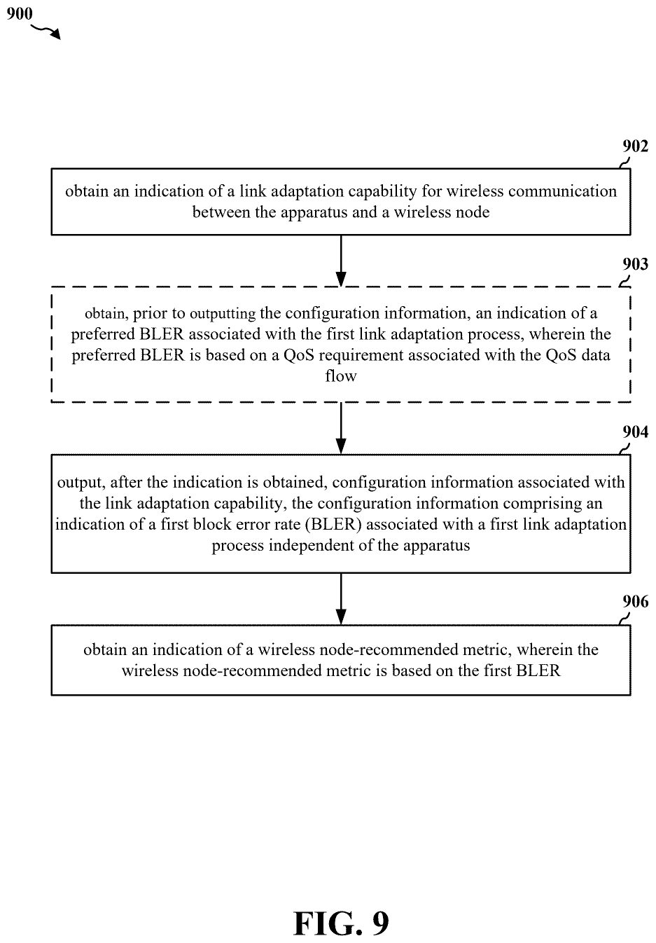

FIG. 9 is a flowchart 900 of a method of wireless communication. The method may be performed by a network entity or base station (e.g., the base station 102/180; the apparatus 1002. Specifically, the method may be performed by one or more memories, processors, and RF front ends (e.g., the memory 376, controller/processor 375, transmitter 318TX, receiver 318RX, antenna 320, etc. of FIG. 3). Optional aspects are illustrated with a dashed line.

At 902, the network entity may obtain an indication of a link adaptation capability for wireless communication between the apparatus and a wireless node. For example, 902 may be performed by an obtaining component 1040.

At 903, the network entity may obtain, prior to outputting the configuration information, an indication of a preferred BLER associated with the first link adaptation process, wherein the preferred BLER is based on a QoS requirement associated with the QoS data flow. For example, 903 may be performed by an obtaining component 1040.

At 904, the network entity may output, after the indication is obtained, configuration information associated with the link adaptation capability, the configuration information comprising an indication of a first block error rate (BLER) associated with a first link adaptation process independent of the apparatus. For example, 904 may be performed by an outputting component 1042.

Finally, at 906, the network entity may obtain an indication of a wireless node-recommended metric, wherein the wireless node-recommended metric is based on the first BLER. For example, 906 may be performed by the obtaining component 1040.

In certain aspects, the first BLER comprises a target BLER or a dynamic BLER.

In certain aspects, the first BLER is different from a second BLER associated with a second link adaptation process performed by the wireless node.

In certain aspects, the first BLER comprises an apparatus-specific BLER, and the second BLER is a wireless node-specific BLER.

In certain aspects, the configuration information further comprises an indication of at least one of: (i) a first threshold condition associated with a scheduling rate, (ii) a second threshold condition associated with a spectral efficiency of the wireless node, or (iii) a time duration associated with one or more of the first threshold condition or the second threshold condition.

In certain aspects, the wireless node-recommended metric is obtained based on satisfaction of both the first threshold condition and the second threshold condition for the time duration.

In certain aspects, the wireless node-recommended metric comprises one or more of:
a modulation coding scheme (MCS), a multiple-input multiple-output (MIMO) layer, a transport block (TB) size, and a concurrent scheduling scheme for wireless node-level control-plane and user-plane information.

In certain aspects, the wireless node-recommended metric comprises an absolute value or a relative value associated with each of the one or more of the MCS, the MIMO layer, the TB size, and the concurrent scheduling scheme.

In certain aspects, the wireless node-recommended metric is obtained via a medium access control-control element (MAC-CE), a radio resource control (RRC) message, or a channel state information (CSI) report.

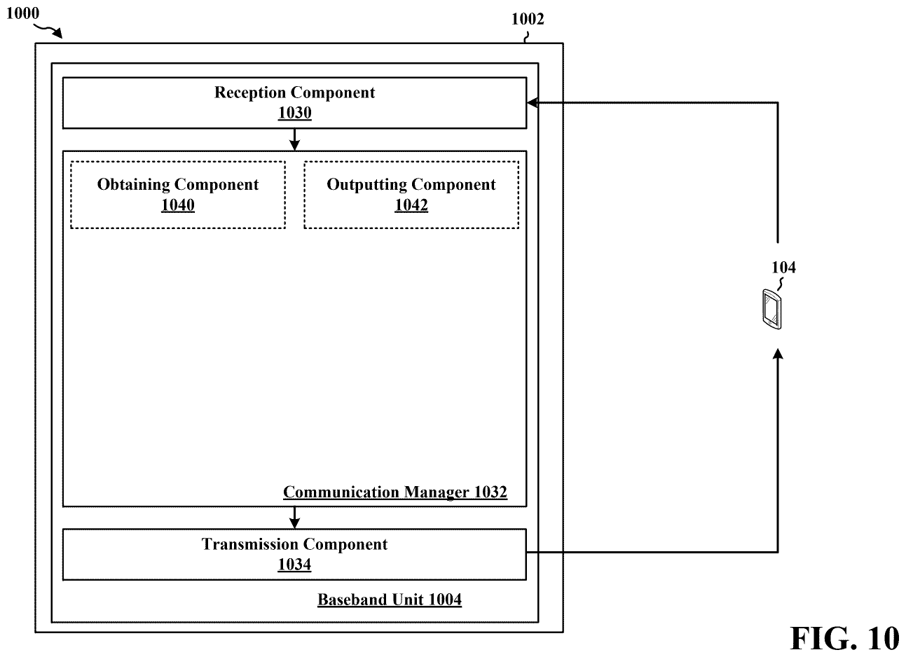

FIG. 10 is a diagram 1000 illustrating an example of a hardware implementation for an apparatus 1002. The apparatus 1002 is a BS and includes a baseband unit 1004. The baseband unit 1004 may communicate through one or more cellular RF transceivers with the UE 104. The baseband unit 1004 may include a computer-readable medium/memory. The baseband unit 1004 is responsible for general processing, including the execution of software stored on the computer-readable medium/memory. The software, when executed by the baseband unit 1004, causes the baseband unit 1004 to perform the various functions described supra. The computer-readable medium/memory may also be used for storing data that is manipulated by the baseband unit 1004 when executing software. The baseband unit 1004 further includes a reception component 1030, a communication manager 1032, and a transmission component 1034. The communication manager 1032 includes the one or more illustrated components. The components within the communication manager 1032 may be stored in the computer-readable medium/memory and/or configured as hardware within the baseband unit 1004. The baseband unit 1004 may be a component of the BS 102/180 and may include the memory 376 and/or at least one of the TX processor 316, the RX processor 370, and the controller/processor 375.

In various examples, the apparatus 1002 can be a chip, SoC, chipset, package or device that may include: one or more modems (such as a Wi-Fi (IEEE 802.11) modem or a cellular modem such as 3 4G LTE or 5G compliant modem); one or more processors, processing blocks or processing elements (collectively “the processor”); one or more radios (collectively “the radio”); and one or more memories or memory blocks (collectively “the memory”).

The communication manager 1032 includes an obtaining component 1040 configured to: obtain an indication of a link adaptation capability for wireless communication between the apparatus and a wireless node; obtain an indication of a wireless node-recommended metric, wherein the wireless node-recommended metric is based on the first BLER; and obtain, prior to outputting the configuration information, an indication of a preferred BLER associated with the first link adaptation process, wherein the preferred BLER is based on a QoS requirement associated with the QoS data flow; e.g., as described in connection with 902, 903, and 906.

The communication manager 1032 further includes an outputting component 1042 configured to output, after the indication is obtained, configuration information associated with the link adaptation capability, the configuration information comprising an indication of a first block error rate (BLER) associated with a first link adaptation process independent of the apparatus, e.g., as described in connection with 904.

The apparatus may include additional components that perform each of the blocks of the algorithm in the aforementioned flowchart of FIG. 9. As such, each block in the aforementioned flowchart may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1002, and in particular the baseband unit 1004, includes: means for obtaining an indication of a link adaptation capability for wireless communication between the apparatus and a wireless node; means for outputting, after the indication is obtained, configuration information associated with the link adaptation capability, the configuration information comprising an indication of a first block error rate (BLER) associated with a first link adaptation process independent of the apparatus; and means for obtaining an indication of a wireless node-recommended metric, wherein the wireless node-recommended metric is based on the first BLER.

The aforementioned means may be one or more of the aforementioned components of the apparatus 1002 configured to perform the functions recited by the aforementioned means. As described supra, the apparatus 1002 may include the TX Processor 316, the RX Processor 370, and the controller/processor 375. As such, in one configuration, the aforementioned means may be the TX Processor 316, the RX Processor 370, and the controller/processor 375 configured to perform the functions recited by the aforementioned means.

Means for receiving or means for obtaining may include a receiver, such as the receive processor 370 and/or antenna(s) 320 of the network entity 102/180 illustrated in FIG. 3. Means for transmitting or means for outputting may include a transmitter such as the transmit processor 316 or antenna(s) 320 of the network entity 102/180 illustrated in FIG. 3. Means for selecting, means for detecting, means for determining, and means for generating may include a processing system, which may include one or more processors, such as the controller/processor 375, the memory 376, and/or any other suitable hardware components of the network entity 102/180 illustrated in FIG. 3.

In some cases, rather than actually transmitting a frame a device may have an interface to output a frame for transmission (a means for outputting). For example, a processor may output a frame, via a bus interface, to a radio frequency (RF) front end for transmission. Similarly, rather than actually receiving a frame, a device may have an interface to obtain a frame received from another device (a means for obtaining). For example, a processor may obtain (or receive) a frame, via a bus interface, from an RF front end for reception.

### Additional Considerations

As used herein, a processor, at least one processor, and/or one or more processors, individually or in combination, configured to perform or operable for performing a plurality of actions is meant to include at least two different processors able to perform different, overlapping or non-overlapping subsets of the plurality actions, or a single processor able to perform all of the plurality of actions. In one non-limiting example of multiple processors being able to perform different ones of the plurality of actions in combination, a description of a processor, at least one processor, and/or one or more processors configured or operable to perform actions X, Y, and Z may include at least a first processor configured or operable to perform a first subset of X, Y, and Z (e.g., to perform X) and at least a second processor configured or operable to perform a second subset of X, Y, and Z (e.g., to perform Y and Z). Alternatively, a first processor, a second processor, and a third processor may be respectively configured or operable to perform a respective one of actions X, Y, and Z. It should be understood that any combination of one or more processors each may be configured or operable to perform any one or any combination of a plurality of actions.

As used herein, a memory, at least one memory, and/or one or more memories, individually or in combination, configured to store or having stored thereon instructions executable by one or more processors for performing a plurality of actions is meant to include at least two different memories able to store different, overlapping or non-overlapping subsets of the instructions for performing different, overlapping or non-overlapping subsets of the plurality actions, or a single memory able to store the instructions for performing all of the plurality of actions. In one non-limiting example of one or more memories, individually or in combination, being able to store different subsets of the instructions for performing different ones of the plurality of actions, a description of a memory, at least one memory, and/or one or more memories configured or operable to store or having stored thereon instructions for performing actions X, Y, and Z may include at least a first memory configured or operable to store or having stored thereon a first subset of instructions for performing a first subset of X, Y, and Z (e.g., instructions to perform X) and at least a second memory configured or operable to store or having stored thereon a second subset of instructions for performing a second subset of X, Y, and Z (e.g., instructions to perform Y and Z). Alternatively, a first memory, and second memory, and a third memory may be respectively configured to store or have stored thereon a respective one of a first subset of instructions for performing X, a second subset of instruction for performing Y, and a third subset of instructions for performing Z. It should be understood that any combination of one or more memories each may be configured or operable to store or have stored thereon any one or any combination of instructions executable by one or more processors to perform any one or any combination of a plurality of actions. Moreover, one or more processors may each be coupled to at least one of the one or more memories and configured or operable to execute the instructions to perform the plurality of actions. For instance, in the above non-limiting example of the different subset of instructions for performing actions X, Y, and Z, a first processor may be coupled to a first memory storing instructions for performing action X, and at least a second processor may be coupled to at least a second memory storing instructions for performing actions Y and Z, and the first processor and the second processor may, in combination, execute the respective subset of instructions to accomplish performing actions X, Y, and Z. Alternatively, three processors may access one of three different memories each storing one of instructions for performing X, Y, or Z, and the three processor may in combination execute the respective subset of instruction to accomplish performing actions X, Y, and Z. Alternatively, a single processor may execute the instructions stored on a single memory, or distributed across multiple memories, to accomplish performing actions X, Y, and Z.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

### Example Aspects

The following examples are illustrative only and may be combined with aspects of other embodiments or teachings described herein, without limitation.

Example 1 is a method for wireless communication at a first wireless node, comprising: outputting an indication of a link adaptation capability for wireless communication between the first wireless node and a second wireless node; obtaining, after the indication is output, configuration information associated with the link adaptation capability, the configuration information comprising an indication of a first block error rate (BLER) associated with a first link adaptation process independent of the first wireless node; and outputting an indication of a first wireless node-recommended metric that is based on the first BLER.

Example 2 is the method of Example 1, wherein the first BLER comprises a target BLER or a dynamic BLER.

Example 3 is the method of any of Examples 1 and 2, wherein the first BLER is different from a second BLER associated with a second link adaptation process performed by the first wireless node.

Example 4 is the method of Example 3, wherein the first BLER comprises a first wireless node-specific BLER, and the second BLER is a first wireless node-specific BLER.

Example 5 is the method of any of Examples 1-4, wherein the indication of the apparatus-recommended metric is a first indication associated with a quality of service (QoS) data flow, and wherein the method further comprises: outputting, prior to obtaining the configuration information, an indication of a preferred BLER associated with the first link adaptation process, wherein the preferred BLER is based on a QoS requirement associated with the QoS data flow.

Example 6 is the method of Example 5, wherein the first BLER is equal to the preferred BLER.

Example 7 is the method of any of Examples 1-6, wherein the configuration information further comprises an indication of at least one of: (i) a first threshold condition associated with a scheduling rate, (ii) a second threshold condition associated with a spectral efficiency of the first wireless node, or (iii) a time duration associated with one or more of the first threshold condition or the second threshold condition.

Example 8 is the method of Example 7, further comprising generating the first wireless node-recommended metric based on satisfaction of both the first threshold condition and the second threshold condition for the time duration.

Example 9 is the method of any of Examples 1-8, wherein the first wireless node-recommended metric comprises one or more of: a modulation coding scheme (MCS), a multiple-input multiple-output (MIMO) layer, a transport block (TB) size, and a concurrent scheduling scheme for first wireless node-level control-plane and user-plane information.

Example 10 is the method of Example 9, wherein the first wireless node-recommended metric comprises an absolute value or a relative value associated with each of the one or more of the MCS, the MIMO layer, the TB size, and the concurrent scheduling scheme.

Example 11 is the method of any of Examples 1-10, wherein the first wireless node-recommended metric is output via a medium access control-control element (MAC-CE), a radio resource control (RRC) message, or a channel state information (CSI) report.

Example 12 is the method of any of Examples 1-11, wherein the indication of the first wireless node-recommended metric is a first indication associated with a first quality of service (QoS) data flow, and wherein the method further comprises: outputting a second indication of another first wireless node-recommended metric associated with a second QoS data flow, wherein the other first wireless node-recommended metric is based on the first BLER.

Example 13 is a method for wireless communication at a first wireless node, comprising: obtaining an indication of a link adaptation capability for wireless communication between the first wireless node and a second wireless node; outputting, after the indication is obtained, configuration information associated with the link adaptation capability, the configuration information comprising an indication of a first block error rate (BLER) associated with a first link adaptation process independent of the first wireless node; and obtaining an indication of a second wireless node-recommended metric, wherein the second wireless node-recommended metric is based on the first BLER.

Example 14 is the method of Example 13, wherein the first BLER comprises a target BLER or a dynamic BLER.

Example 15 is the method of any of Examples 13 and 14, wherein the first BLER is different from a second BLER associated with a second link adaptation process performed by the second wireless node.

Example 16 is the method of Example 15, wherein the first BLER comprises a first wireless node-specific BLER, and the second BLER is a second wireless node-specific BLER.

Example 17 is the method of Example 15, wherein the indication of the apparatus-recommended metric is a first indication associated with a quality of service (QoS) data flow, and wherein the method further comprises: obtaining, prior to outputting the configuration information, an indication of a preferred BLER associated with the first link adaptation process, wherein the preferred BLER is based on a QoS requirement associated with the QoS data flow.

Example 18 is the method of claim 17, wherein the first BLER is based on the preferred BLER.

Example 19 is the method of any of Examples 13-18, wherein the configuration information further comprises an indication of at least one of: (i) a first threshold condition associated with a scheduling rate, (ii) a second threshold condition associated with a spectral efficiency of the second wireless node, or (iii) a time duration associated with one or more of the first threshold condition or the second threshold condition.

Example 20 is the method of Example 19, wherein the second wireless node-recommended metric is obtained based on satisfaction of both the first threshold condition and the second threshold condition for the time duration.

Example 21 is the method of any of Examples 13-20, wherein the second wireless node-recommended metric comprises one or more of: a modulation coding scheme (MCS), a multiple-input multiple-output (MIMO) layer, a transport block (TB) size, and a concurrent scheduling scheme for second wireless node-level control-plane and user-plane information.

Example 22 is the method of Example 21, wherein the second wireless node-recommended metric comprises an absolute value or a relative value associated with each of the one or more of the MCS, the MIMO layer, the TB size, and the concurrent scheduling scheme.

Example 23 is the method of any of Examples 13-22, wherein the second wireless node-recommended metric is obtained via a medium access control-control element (MAC-CE), a radio resource control (RRC) message, or a channel state information (CSI) report.

Example 24 is an apparatus for wireless communications, comprising means for performing a method in accordance with any one of examples 1-12.

Example 25 is an apparatus for wireless communications, comprising means for performing a method in accordance with any one of examples 13-23.

Example 26 is a non-transitory computer-readable medium comprising instructions that, when executed by a wireless node, cause the wireless node to perform a method in accordance with any one of examples 1-12.

Example 27 is a non-transitory computer-readable medium comprising instructions that, when executed by a wireless node, cause the wireless node to perform a method in accordance with any one of examples 13-23.

Example 28 is an apparatus for wireless communications, comprising: one or more memories, individually or in combination, having instructions; and one or more processors, individually or in combination, configured to execute the instructions to cause the apparatus to perform a method in accordance with any one of examples 1-12.

Example 29 is an apparatus for wireless communications, comprising: one or more memories, individually or in combination, having instructions; and one or more processors, individually or in combination, configured to execute the instructions to cause the apparatus to perform a method in accordance with any one of examples 13-23.

Example 30 is a first wireless node (e.g., user equipment (UE)), comprising: one or more transceivers; one or more memories, individually or in combination, having instructions; and one or more processors, individually or in combination, configured to execute the instructions to cause the first wireless node to perform a method in accordance with any one of examples 1-12, wherein the one or more transceivers are configured to: transmit the indication of the link adaptation capability; receive configuration information; and transmit the indication of the first wireless node-recommended metric.

Example 31 is a first wireless node (e.g., network entity), comprising: one or more transceivers; one or more memories, individually or in combination, having instructions; and one or more processors, individually or in combination, configured to execute the instructions to cause the first wireless node to perform a method in accordance with any one of examples 13-23, wherein the one or more transceivers are configured to: receive the indication of the link adaptation capability; transmit the configuration information; and receive the indication of the first wireless node-recommended metric.

What is claimed is:

1. An apparatus for wireless communication, comprising:
one or more memories, individually or in combination, having instructions; and
one or more processors, individually or in combination, configured to execute the instructions and cause the apparatus to:
output an indication of a link adaptation capability for wireless communication between the apparatus and a wireless node;
obtain, after the indication is output, configuration information associated with the link adaptation capability, the configuration information comprising an indication of a first block error rate (BLER) associated with a first link adaptation process independent of the apparatus; and
output an indication of an apparatus-recommended metric that is based on the first BLER.

2. The apparatus of claim 1, wherein the first BLER comprises a target BLER or a dynamic BLER.

3. The apparatus of claim 1, wherein the first BLER is different from a second BLER associated with a second link adaptation process performed by the apparatus.

4. The apparatus of claim 3, wherein the first BLER comprises a wireless node-specific BLER, and the second BLER is an apparatus-specific BLER.

5. The apparatus of claim 1, wherein the indication of the apparatus-recommended metric is a first indication associated with a quality of service (QoS) data flow, and wherein the one or more processors, individually or in combination, are further configured to cause the apparatus to:
output, prior to the configuration information being obtained, an indication of a preferred BLER associated with the first link adaptation process, wherein the preferred BLER is based on a QoS requirement associated with the QoS data flow.

6. The apparatus of claim 5, wherein the first BLER is equal to the preferred BLER.

7. The apparatus of claim 1, wherein the configuration information further comprises an indication of at least one of: (i) a first threshold condition associated with a scheduling rate, (ii) a second threshold condition associated with a spectral efficiency of the apparatus, or (iii) a time duration associated with one or more of the first threshold condition or the second threshold condition.

8. The apparatus of claim 7, wherein the one or more processors, individually or in combination, are further configured to cause the apparatus to:
generate the apparatus-recommended metric based on satisfaction of both the first threshold condition and the second threshold condition for the time duration.

9. The apparatus of claim 1, wherein the apparatus-recommended metric comprises one or more of: a modulation coding scheme (MCS), a multiple-input multiple-output (MIMO) layer, a transport block (TB) size, and a concurrent scheduling scheme for apparatus-level control-plane and user-plane information.

10. The apparatus of claim 9, wherein the apparatus-recommended metric comprises an absolute value or a relative value associated with each of the one or more of the MCS, the MIMO layer, the TB size, and the concurrent scheduling scheme.

11. The apparatus of claim 1, wherein the apparatus-recommended metric is output via a medium access control-control element (MAC-CE), a radio resource control (RRC) message, or a channel state information (CSI) report.

12. The apparatus of claim 1, wherein the indication of the apparatus-recommended metric is a first indication associated with a first quality of service (QoS) data flow, and wherein the one or more processors, individually or in combination, are further configured to cause the apparatus to:
output a second indication of another apparatus-recommended metric associated with a second QoS data flow, wherein the other apparatus-recommended metric is based on the first BLER.

13. The apparatus of claim 1, further comprising one or more transceivers configured to:
transmit the indication of the link adaptation capability;
receive the configuration information associated with the link adaptation capability; and
transmit the indication of the apparatus-recommended metric, wherein the apparatus is configured as a user equipment (UE).

14. An apparatus for wireless communication, comprising:
one or more memories, individually or in combination, having instructions; and
one or more processors, individually or in combination, configured to execute the instructions and cause the apparatus to:
obtain an indication of a link adaptation capability for wireless communication between the apparatus and a wireless node;
output, after the indication is obtained, configuration information associated with the link adaptation capability, the configuration information comprising an indication of a first block error rate (BLER) associated with a first link adaptation process independent of the apparatus; and
obtain an indication of a wireless node-recommended metric, wherein the wireless node-recommended metric is based on the first BLER.

15. The apparatus of claim 14, wherein the first BLER comprises a target BLER or a dynamic BLER.

16. The apparatus of claim 14, wherein the first BLER is different from a second BLER associated with a second link adaptation process performed by the wireless node.

17. The apparatus of claim 16, wherein the first BLER comprises an apparatus-specific BLER, and the second BLER is a wireless node-specific BLER.

18. The apparatus of claim 14, wherein the configuration information further comprises an indication of at least one of: (i) a first threshold condition associated with a scheduling rate, (ii) a second threshold condition associated with a spectral efficiency of the wireless node, or (iii) a time duration associated with one or more of the first threshold condition or the second threshold condition.

19. The apparatus of claim 14, further comprising one or more transceivers configured to:
receive the indication of the link adaptation capability;
transmit the configuration information associated with the link adaptation capability; and
receive the indication of the wireless node-recommended metric, wherein the apparatus is configured as a network entity.

20. A method for wireless communication at a first wireless node, comprising:
outputting an indication of a link adaptation capability for wireless communication between the first wireless node and a second wireless node;
obtain, after the indication is output, configuration information associated with the link adaptation capability, the configuration information comprising an indication of a first block error rate (BLER) associated with a first link adaptation process independent of the first wireless node; and
output an indication of a first wireless node-recommended metric that is based on the first BLER.
